(19) United States
(12) Patent Application Publication
(10) Pub. No.: US 2002/0143942 A1
(43) Pub. Date: Oct. 3, 2002

(54) Storage area network resource management

(76) Inventors: Hua Li, Plainsboro, NJ (US); Rafael Alonso, Cranbury, NJ (US)

Correspondence Address: STEVE MENDELSOHN, MENDELSOHN & ASSOCIATES, P.C ., 1515 MARKET STREET, SUITE 715, PHILADELPHIA, PA, 19102, US

(21) Appl. No.: 09/950,501

(22) Filed: Sep. 11, 2001

Related U.S. Application Data
(60) Provisional application No. 60/279,370, filed on Mar. 28, 2001.

(51) Int. Cl. G06F 15/173; G06F 7/00; G06F 17/30

(52) U.S. Cl. 709/225; 707/10

(57) ABSTRACT

A storage area network (SAN) resource manager is adapted to provide common management of storage devices in a network that comprises a heterogeneous SAN in which different storage devices are separately managed by different SAN subsystems management applications that communicate with storage device management agents residing on the storage devices to set operational parameters of and receive management information from the storage devices. The SAN resource manager communicates with the SAN subsystems management applications, causing each SAN subsystems management application to set operational parameters of and receive management information from the storage devices it manages and to communicate received management information to the SAN resource manager. The SAN resource manager may also manage SAN networking devices, so that all SAN resources are under common management. The SAN resource manager may be operated as a stand-alone application or may be integrated with higher level management applications to place SAN resources under common management with other network resources.

### BACKGROUND OF THE INVENTION

1. Field of the Invention

The present invention relates to storage area networks and, in particular, to management of storage area network resources.

### CROSS-REFERENCE TO RELATED APPLICATIONS

This nonprovisional U.S. national application, filed under 35 U.S.C. §111(a), claims, under 35 U.S.C. §119(e)(1), the benefit of the filing date of provisional U.S. national application No. 60/279,370, filed under 35 U.S.C. §111(b) on Mar. 28, 2001 as attorney docket no. SAR14273PROV, the teachings of which are incorporated herein by reference.

2. Description of the Related Art

Information storage is a fast-growing area of the computer industry. Existing storage solutions, such as directly-attached storage (DAS) and network-attached storage (NAS), are being stretched to their limits to keep up with the increase in storage demand.

Storage area networks based on fibre channel technology have been developed to address enterprise storage needs. A storage area network (SAN) is a network of elements, including multiple servers, multiple storage devices (such as disk arrays and tape libraries), and a high-speed network of interconnecting elements (such as fibre channels, switches, hubs, and bridges) that establishes direct and indirect connections between the servers, between the storage devices, and between the servers and the storage devices.

A SAN offers many potential benefits. By making servers and storage devices peers on a common network, service providers can implement clustering configurations to maximize server availability. Individual servers can be inserted into or removed from a SAN without disrupting ongoing transactions. Since no server is the exclusive owner of any SAN storage device, server resources can be manipulated without affecting storage availability or administration. In a SAN environment, storage does not depend on the availability of any single access point; any storage device is accessible from any server on the SAN. Additional storage devices can be hot-plugged into a SAN without taking any server resource down. Unlike a storage network with multiple storage devices on a single Small Computer Systems Interface (SCSI) chain, a switched SAN can deliver full bandwidth to every storage device. SANs enable data backup traffic to be moved from a local area network (LAN) or wide area network (WAN), where bottlenecks may exist, and onto the SAN, where bandwidth is readily available.

SAN management tools that are available on the market are often vendor-dependent and system-dependent. However, SANs often operate in heterogeneous environments, and so management of SAN resources can be a difficult task for storage administrators because of the disparate elements comprising the SAN.

### SUMMARY OF THE INVENTION

The present invention is directed to managing SAN resources in a heterogeneous environment, such as in a network that comprises a heterogeneous SAN having a plurality of servers, a plurality of storage devices, at least one networking device interconnecting said servers and said storage devices, and a plurality of SAN subsystems management applications, in which each of the SAN subsystems management applications manages one or more storage devices by communicating with a storage device management agent residing on the storage device to set operational parameters of and receive management information from the storage device.

According to one embodiment, the present invention is a SAN resource manager comprising a server application adapted to reside on one of the servers and communicate with the SAN subsystems management applications causing each of the SAN subsystems management application to set operational parameters of and receive management information from the storage devices it manages and to communicate received management information to the server application, wherein the SAN resource manager is adapted to provide common management of the storage devices.

According to another embodiment, the present invention is a method of managing a heterogeneous SAN comprising the steps of communicating from a SAN resource manager to the SAN subsystems management applications causing each said SAN subsystems management application to set operational parameters of and receive management information from the storage devices it manages and to communicate received management information to the SAN resource manager, and receiving, in the SAN resource manager, management information communicated by the SAN subsystems management applications, wherein the SAN resource manager provides common management of the storage devices.

### BRIEF DESCRIPTION OF THE DRAWINGS

Other aspects, features, and advantages of the present invention will become more fully apparent from the following detailed description, the appended claims, and the accompanying drawings in which:

FIG. 1 is a schematic diagram illustrating a hierarchical model of a network that includes SAN resource management in accordance with one embodiment of the present invention.

FIG. 2 is a schematic diagram illustrating physical elements of the network of FIG. 1.

FIG. 3 is a schematic diagram illustrating an object-oriented view of the network of FIGS. 1 and 2.

### DETAILED DESCRIPTION

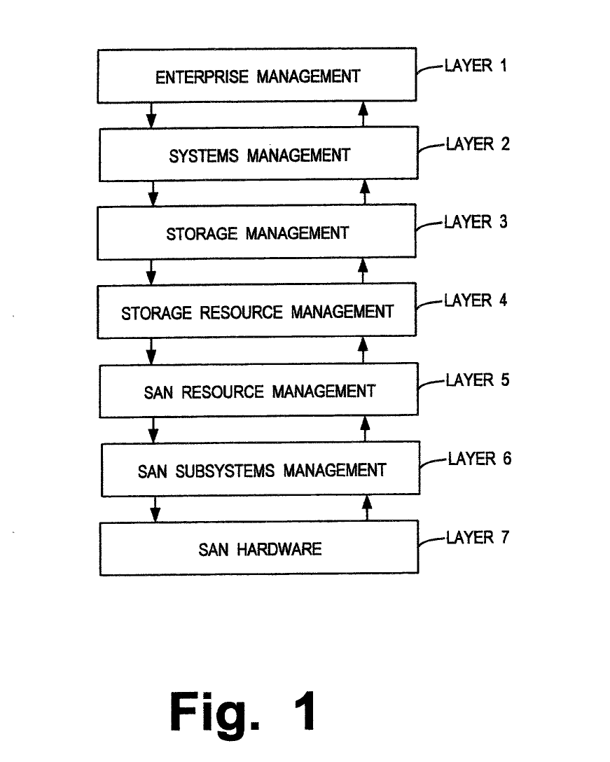

FIG. 1 is a schematic diagram illustrating a hierarchical model of a network that includes SAN resource management in accordance with one embodiment of the present invention. At the highest layer, Layer 1, enterprise-wide management platforms oversee a variety of functions such as policies and security, and are fed status information from the multiple networking and storage infrastructures to provide a global view of the network. Layer 2, Systems Management, addresses issues including network administration and system performance. Layer 3, Storage Management, is concerned with storage strategies including tape backup, data recovery, and data placement. Layer 4 is Storage Resource Management, which deals with storage issues including data capacity, events, and storage allocation. Storage Resource Managers are typically collections of automated tools that enable administrators to visualize, measure, and report on storage capacity, utilization, health, performance, and availability of distributed collections of storage resources including DAS, NAS, and SAN storage. They allow optimization of use of existing storage and planning for growth in the storage system. SAN Resource Management at Layer 5 deals with management of the SAN, including its storage and transport resources. Management of the SAN requires visibility to all aspects of its data transport and storage. Beneath SAN Resource Management is Layer 6, SAN Subsystems Management, which manages specific SAN elements and is often SAN vendor dependent. At the bottom level, Layer 7, management of the SAN interconnect or transport is dependent on hardware that supports intelligent features, typically Simple Network Management Protocol (SNMP) agents that can report status and respond to commands. The interfaces between different management layers may be as straightforward as event logs or SNMP traps, or as sophisticated as application programming interfaces (APIs).

Embodiments of the present invention focus principally on three layers of the FIG. 1 model: Storage Resource Management (Layer 4), SAN Resource Management (Layer 5), and SAN Subsystems Management (Layer 6). One possible system in accordance with the present invention operates primarily at Layer 5; it integrates the management of disparate SAN subsystems and devices of Layers 6 and/or 7. Such a system of the present invention also enables management of SAN resources by Layer 4 and higher level management applications, so that management of SAN resources can be integrated with management of other storage resources and other aspects of the network.

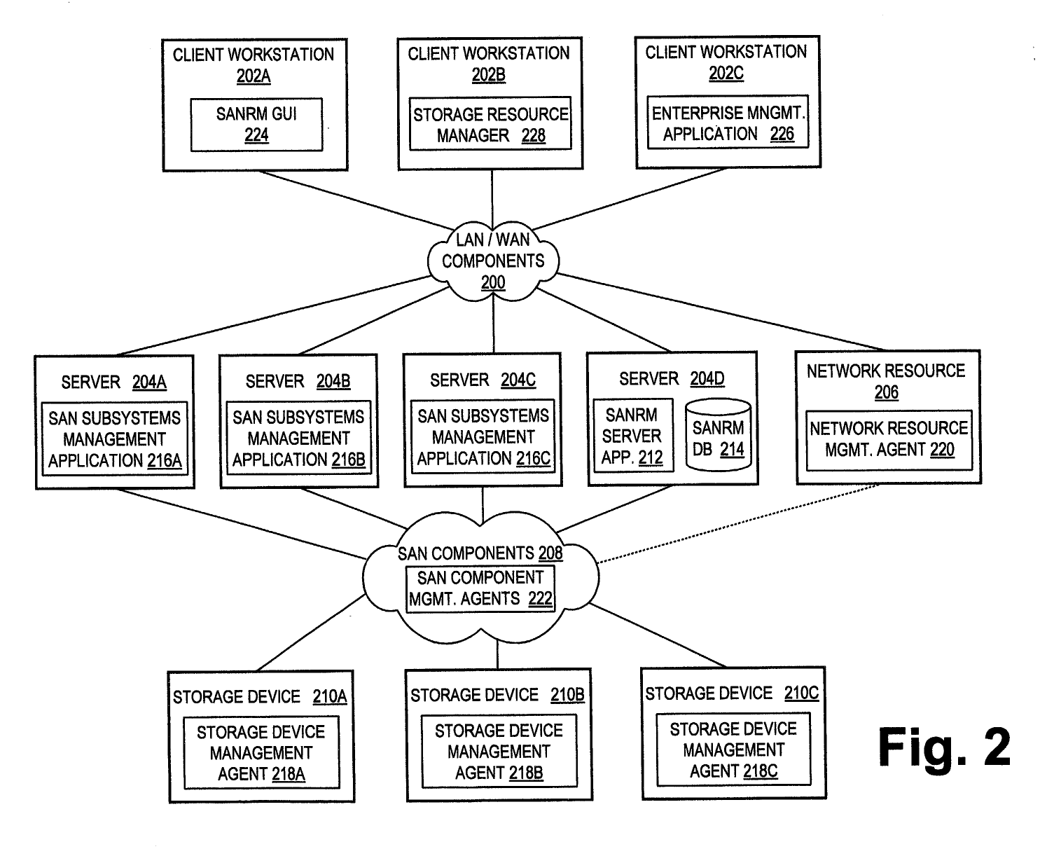

FIG. 2 is a schematic diagram illustrating physical elements of the network of FIG. 1. The network includes local area and/or wide area LAN/WAN networking components 200 through which client workstations 202, servers 204, and other network resources 206 (such as network attached storage) are interconnected in a LAN/WAN. The network also includes SAN networking components 208 (such as fibre channels, switches, hubs, and bridges) by means of which servers 204 and SAN storage devices 210 are interconnected in a storage area network. Other network resources 206 may be connected in the SAN as well. Although such a network may be homogeneous, it need not be and often is not. The present invention is directed to heterogeneous networks, that is, networks in which the hardware and/or software components are different, in that they rely on different hardware technologies, or use different operating system or application software, or use different protocols for handling or communicating data. For instance, SAN storage device 210A may be a RAID (redundant array of inexpensive disks), SAN storage device 210B may be a tape drive, SAN storage device 210C may be an optical drive, server 204A may be a Windows NT® server, and server 204B may be a UNIX server. A heterogeneous network often results when products from different manufacturers are included in the network.

The network shown in FIG. 2 includes software for management of various network aspects. One type of management software in the network of FIG. 2 is the management agent. A management agent resides in a device to be managed, enables operational parameters of the device to be set, and generates status data regarding the device, either in response to a request for status data or autonomously in response to the occurrence of some condition or event. Thus, SAN storage devices 210A, 210B, and 210C include storage device management agents 218A, 218B, and 218C, respectively, SAN networking components 208 include SAN component management agents 222, and other network resources 206 may include management agents 220. For ease of illustration, the SAN networking components 208 (as well as the LAN/WAN networking components 200) are shown collectively as clouds rather than as individual devices, and the SAN component management agents 222 are shown collectively as a single block. Management agents 218, 220, and 222 operate at Layer 7 of the hierarchical model of FIG. 1.

Another type of management software in the network of FIG. 2 is the management application, sometimes referred to as a manager, which receives status data from a management agent in a device, monitors operation of the device, and sets operational parameters of the device. A management application for SAN storage devices or SAN networking components typically resides in a server 204; three such SAN subsystems management applications, 216A, 216B, and 216C, are illustrated in FIG. 2 residing in servers 204A, 204B, and 204C, respectively, although one server can host several such applications. SAN subsystems management applications 216 operate at Layer 6 of the hierarchical model of FIG. 1.

Client workstations 202 include other management application software. Illustrated in FIG. 2 are an enterprise management application 226, residing in client workstation 202C and operating at Layer 1 of the hierarchical model of FIG. 1, and a storage resource manager 228, residing in client workstation 202B and operating at Layer 4 of the hierarchical model of FIG. 1.

Typical SAN subsystems management applications 216 that manage SAN storage devices 210 are vendor-specific in that they only manage storage devices of a specific vendor. Many networks are heterogeneous, and it can be difficult in such networks to manage a SAN and its component devices using disparate vendor-specific management applications. The present invention is intended to address such difficulties.

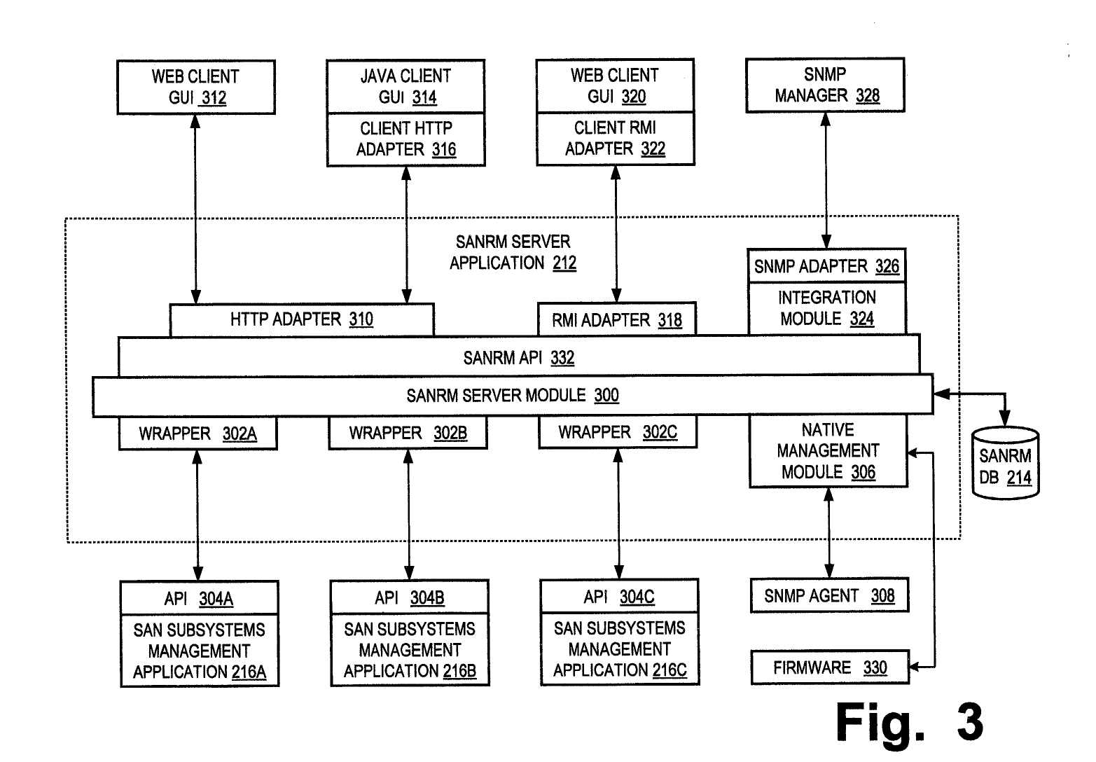

In accordance with the present invention, the network of FIG. 2 includes a SAN resource manager, which may be referred to by the abbreviation “SANRM” in the drawings and the following description. The SAN resource manager includes a SANRM server application 212 hosted on server 204D and a SANRM database 214. SANRM database 214 is illustrated as residing on SANRM host server 204D but can also reside on another server 204, on a SAN storage devices 210, or on network-attached storage. The SAN resource manager preferably includes a SANRM graphical user interface (GUI) 224 residing on a client workstation, such as client workstation 202A, which enables the SAN resource manager to be operated as a stand-alone application. Alternatively or in addition, the SAN resource manager may be operated by higher level management applications such as enterprise management application 226 or storage resource manager 228. Operation of the SAN resource manager is described below with respect to FIG. 3.

FIG. 3 is a schematic diagram illustrating an object-oriented view of the network of FIGS. 1 and 2. In this view, SANRM server application 212 lies in the middle region of the figure, the lower-level objects with which the SAN resource manager communicates in managing the SAN occupy the lower region of the figure, and the client objects with which the SAN resource manager communicates occupy the upper region of the figure. The SANRM server application 212 illustrated comprises a plurality of modules, including SANRM server module 300, which effects the management of lower-level objects; modules, such as wrapper modules 302 and native management module 306, that interface SANRM server module 300 to the lower-level objects it manages; and modules including adapter modules 310, 318, and 326 that interface SANRM server module 300 to higher-level client objects.

A client application, which may be a GUI or a higher level management application, interacts with the SANRM server module 300 through its SANRM API 332 to manage the SAN (and optionally to manage other resources). SANRM server application 212 includes several protocol adapters, which translate network messages from their communication protocol into a protocol understood by the SANRM server module 300, and FIG. 3 illustrates several ways in which SANRM server module 300 may be accessed using them. SANRM server application 212 includes a hypertext transfer protocol (HTTP) adapter 310, by which a web client GUI 312 may access SANRM server module 300 and by which a Java client GUI 314 may access SANRM server module 300 via a client HTTP adapter 316. SANRM server application 212 also includes a remote method invocation (RMI) adapter 318, by which a web client GUI 320 may access SANRM server module 300 via a client RMI adapter 322. SANRM GUI 224 of FIG. 2 may be implemented in the manner indicated by client GUI 312, 314, or 320 of FIG. 3. To permit integration with or operation by a higher level management application, SANRM server application 212 includes an integration module 324 and an SNMP adapter 326; these provide a programmatic interface to enable an enterprise management application 226 or a storage resource manager 228 having an SNMP manager 328 to interact with SANRM server module 300.

In accordance with an important aspect of the invention, the SAN resource manager manages a plurality of disparate SAN devices. FIG. 3 illustrates several ways in which this may be accomplished. SANRM server module 300 may invoke the services of a SAN subsystems management application 216 via a wrapper module 302 that conforms to the API 304 of the SAN subsystems management application 216. Each wrapper module provides mediation between SANRM server module 300 and a particular SAN subsystems management application 216 and enables SANRM server module 300 to operate the particular SAN subsystems management application 216. Because in a heterogeneous network each SAN subsystems management application 216 may have a different API, SANRM server application 212 may include a plurality of wrapper modules 302A, 302B, and 302C, so that an appropriate wrapper is provided for each API 304A, 304B, and 304C of the SAN subsystems management applications 216A, 216B, and 216C, respectively, whose services are to be invoked. The SAN resource manager may also directly manage a SAN device by means of native management module 306, which interacts with an SNMP agent 308 or firmware 330 in a SAN device to provide native management of the device. For instance, the SAN resource manager can communicate directly with a network-attached or directly-attached RAID controller or its host-based proxy over the network by sending messages to fetch status information and to convey new or updated configuration/tuning parameters to the controller.

Operation of the network of FIGS. 2 and 3 is as follows. From a client workstation 202, a client application (GUI 224 or higher level management application 226, 228) communicates with SANRM server application 212 by interchanging messages over the LAN/WAN to effect management of the SAN and other resources. SANRM server application 212 polls the SAN subsystems management applications 216, each of which in turn polls the management agents residing on the SAN networking components 208 and/or the SAN storage devices 210 it manages. SANRM server application 212 also polls the management agents residing on the SAN networking components 208 and/or the SAN storage devices 210 that it directly manages through its native management module 306. Such polling may be undertaken autonomously, such as periodically or at other intervals, or in response to certain conditions. Such polling may also be undertaken in response to receipt by SANRM server module 300 of a message from a client. If SANRM server module 300 receives a request from a client relating to SAN resources, it forwards such request to the appropriate management agent 218 or 222, either directly in the case of directly-managed SAN resources or to the responsible SAN subsystems management application 216 in the case of indirectly-managed SAN resources.

The SANRM server application 212 receives management information from management agents 218, 220 (either directly, or indirectly from SAN subsystems management applications 216 via wrapper modules 302) and updates SANRM database 214 so as to make current management information regarding the history and status of SAN resources available in SANRM database 214. Such management information includes responses by the management agents to polling by the SANRM server application 212 as well as responses to client requests that are forwarded by the SANRM server application 212 to the management agents. Such information also includes event or trap information generated by management agents 218, 220 autonomously in response to the occurrence of predetermined events or conditions. In addition to storing such event and trap information in SANRM database 214, SANRM server application 212 also relays event and trap information to the client(s) for GUI display and action by the user and/or by higher level management applications. Management information maintained in SANRM database 214 is available to client applications. Client applications can change the settings of a SAN resource by sending a request to SANRM server application 212 which it then forwards to the appropriate management agent 218 or 220, either directly or via the appropriate SAN subsystems management application 216.

The SAN resource manager can also manage other network resources 206 such as NAS in the manner described above with respect to SAN resources. However, unless such network resources 206 are provided with a connection to the SAN, as indicated by the dotted line in FIG. 2, communication between the SANRM server application 212 and the network resource management agent 220 will take place on the LAN/WAN.

The SAN resource manager architecture of the present invention enables changes to the SAN to be easily accommodated. If a new SAN subsystems management application 216 is added, for instance to support a new SAN storage device 210 added to the SAN, its operation can be integrated with the SAN resource manager simply by providing a new wrapper module 302 conforming to the API 304 of the new SAN subsystems management application 216. No change in the other modules of the SANRM server application 212 or in the client applications is needed.

The SAN resource manager architecture described herein is an open architecture for a centralized management of heterogeneous storage area network resources often found in an enterprise setting. The architecture allows for upward and downward compatibility and manageability, easy maintenance, and extensibility for storage system evolution. The SAN resource manager architecture provides anywhere and anytime GUI-based management, vendor-neutral management of SAN resources and other network resources in a common management environment, integration with higher level management applications, and native management support of network resources.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

In any implementation of a SAN resource manager according to the present invention, the program code will depend on the particulars of the servers, storage devices, and networking devices that comprise the SAN, and the SNMP agents, SAN subsystems management applications, client GUIs, and/or higher level management applications with which the SAN resource manager must communicate to manage the SAN. It is believed that persons having ordinary skill in the relevant arts would be capable of generating, without undue experimentation, program code implementing a SAN resource manager in accordance with the present invention in a particular network given an adequate specification of the hardware and software comprising the network.

It will be further understood that various changes in the details, materials, and arrangements of the parts which have been described and illustrated in order to explain the nature of this invention may be made by those skilled in the art without departing from the principle and scope of the invention as expressed in the following claims.

What is claimed is:

1. A storage area network (SAN) resource manager for use in a network that comprises a heterogeneous SAN, said SAN having a plurality of servers, a plurality of storage devices, at least one networking device interconnecting said servers and said storage devices, and a plurality of SAN subsystems management applications, each of said SAN subsystems management applications managing one or more storage devices by communicating with a storage device management agent residing on said storage device to set operational parameters of and receive management information from said storage device, said SAN resource manager comprising a server application adapted to reside on one of said servers and communicate with said SAN subsystems management applications causing each said SAN subsystems management application to set operational parameters of and receive management information from the storage devices it manages and to communicate received management information to said server application, wherein said SAN resource manager is adapted to provide common management of said storage devices.

2. The invention of claim 1, wherein said SAN resource manager includes a database and stores management information received by said server application in said database.

3. The invention of claim 1, wherein said SAN resource manager includes a client GUI application adapted to communicate with said server application to manage said storage devices.

4. The invention of claim 1, wherein said SAN resource manager includes an integration module adapted to enable a storage resource manager, an enterprise management application, or other higher level management application to communicate with said server application to manage said storage devices.

5. The invention of claim 1, wherein said SAN resource manager includes a native management module adapted to enable said server application to communicate with and directly manage said storage devices.

6. The invention of claim 1, wherein said SAN resource manager includes a plurality of wrapper modules, each said wrapper module being adapted to mediate communication between said server application and one of said SAN subsystems management applications.

7. The invention of claim 1, wherein said networking device has a networking device management agent residing thereon, and wherein said SAN resource manager is adapted to communicate with said networking device management agent to cause said networking device management agent to set operational parameters of said networking device and to communicate management information regarding said networking device to said SAN resource manager.

8. The invention of claim 1, wherein said SAN resource manager includes:
a database, said SAN resource manager storing management information received by said server application in said database;
at least one of a client GUI application and an integration module, said client GUI application being adapted to communicate with said server application to manage said storage devices, and said integration module being adapted to enable a storage resource manager, an enterprise management application, or other higher level management application to communicate with said server application to manage said storage devices;
a native management module adapted to enable said server application to communicate with and directly manage said storage devices; and
a plurality of wrapper modules, each said wrapper module being adapted to mediate communication between said server application and one of said SAN subsystems management applications.

9. A method of managing a heterogeneous storage area network, said network having a plurality of servers, a plurality of storage devices, at least one networking device interconnecting said servers and said storage devices, and a plurality of SAN subsystems management applications, each of said SAN subsystems management applications managing at least one storage device by communicating with a storage device management agent residing on said storage device to set operational parameters of and receive management information from said storage device, comprising the steps of:
communicating from a SAN resource manager to said SAN subsystems management applications causing each said SAN subsystems management application to set operational parameters of and receive management information from the storage devices it manages and to communicate received management information to said SAN resource manager; and
receiving, in said SAN resource manager, management information communicated by said SAN subsystems management applications,
wherein said SAN resource manager provides common management of said storage devices.

10. The invention of claim 9, further comprising the step of storing management information received by said SAN resource manager in a database.

11. The invention of claim 9, further comprising the step of controlling the operation of said SAN resource manager by a client GUI application.

12. The invention of claim 9, further comprising the step of controlling the operation of said SAN resource manager by a storage resource manager, an enterprise management application, or other higher level management application.

13. The invention of claim 9, further comprising the steps of:
communicating from said SAN resource manager to at least one of said storage device management agents causing said storage device management agent to set operational parameters of the storage devices it manages and to communicate management information from the storage devices it manages to said SAN resource manager; and
receiving, in said SAN resource manager, management information communicated by said storage device management agent,
whereby said SAN resource manager provides direct management of said storage device.

14. The invention of claim 9, wherein said communicating step includes communicating between a wrapper module comprising said SAN resource manager and said SAN subsystems management applications.

15. The invention of claim 9, wherein said networking device has a networking device management agent residing thereon, said networking device management application setting operational parameters of said networking device in response to received communications and communicating management information regarding the networking device, further comprising the step of said SAN resource manager communicating with said networking device management agent to manage said networking device.

16. The invention of claim 9, wherein said communicating step includes communicating between a wrapper module comprising said SAN resource manager and said SAN subsystems management applications, further comprising the steps of:
storing management information received by said SAN resource manager in a database;
controlling the operation of said SAN resource manager by a client GUI application or by a storage resource manager, an enterprise management application, or other higher level management application;
communicating from said SAN resource manager to at least one of said storage device management agents causing said storage device management agent to set operational parameters of the storage devices it manages and to communicate management information from the storage devices it manages to said SAN resource manager; and
receiving, in said SAN resource manager, management information communicated by said storage device management agent.

17. A machine-readable medium, having encoded thereon program code, wherein, when the program code is executed by a machine, the machine implements a method of managing a heterogeneous storage area network, said network having a plurality of servers, a plurality of storage devices, at least one networking device interconnecting said servers and said storage devices, and a plurality of SAN subsystems management applications, each of said SAN subsystems management applications managing at least one storage device by communicating with a storage device management agent residing on said storage device to set operational parameters of and receive management information from said storage device, comprising the steps of:
communicating from a SAN resource manager to said SAN subsystems management applications causing each said SAN subsystems management application to set operational parameters of and receive management information from the storage devices it manages and to communicate received management information to said SAN resource manager; and
receiving, in said SAN resource manager, management information communicated by said SAN subsystems management applications,
wherein said SAN resource manager provides common management of said storage devices.

18. A network including a heterogeneous storage area network (SAN), said network comprising:
a plurality of servers;
a plurality of storage devices, each of said storage devices having a storage device management agent residing thereon, each said storage device management agent setting operational parameters of the storage device on which it resides in response to received communications and communicating management information regarding the storage device on which it resides;
at least one networking device interconnecting said servers and said storage devices in a storage area network;
a plurality of SAN subsystems management applications, each residing on one of said servers and managing one or more of said storage devices, each SAN subsystems management application managing at least one storage device by communicating with the storage device management agent residing on said storage device to set operational parameters of and receive management information from said storage device; and
a SAN resource manager residing on one of said servers and communicating with said SAN subsystems management applications, said SAN resource manager causing each said SAN subsystems management application to set operational parameters of and receive management information from the storage devices it manages and to communicate received management information to said SAN resource manager, wherein said SAN resource manager provides common management of said storage devices.
